(19) United States
(12) Patent Application Publication
(10) Pub. No.: US 2026/0341297 A1
(43) Pub. Date: Oct. 29, 2026

(54) Source Separation by Equivariant Flow Matching

(71) Applicant: GDM Holding LLC, Mountain View, CA (US)

(72) Inventors: Robin Scheibler, Hino (JP); Arnaud Doucet, Oxford (GB); John Hershey, Mountain View, CA (US); Henry Li, Mountain View, CA (US)

(73) Assignee: GDM Holding LLC, Mountain View, CA (US)

(21) Appl. No.: 19/574,741

(22) Filed: Mar. 23, 2026

Related U.S. Application Data
(60) Provisional application No. 63/793,566, filed on Apr. 23, 2025.

(51) Int. Cl. G10L 21/0272; G06F 17/14; G06N 3/045; G10L 19/018

(52) U.S. Cl. CPC G10L 21/0272; G06F 17/148; G06N 3/045; G10L 19/018

(57) ABSTRACT

A method includes receiving a time-frequency representation of a mixture audio signal that includes two or more source signals. The method includes projecting the time-frequency representation onto a fixed-sized embedding vector that includes a time dimension, a frequency band dimension, a source dimension, and a features dimension. The method also includes generating an output embedding vector based on the fixed-sized embedding vector from the splitter and a diffusion time embedding. The method includes generating a reconstructed time-frequency representation by averaging overlapping frequency bands to restore original frequency dimensions from the output embedding vector. The method also includes generating refined separated source embeddings by combining the reconstructed time-frequency representation and an embedding derived from the mixture audio signal. The method includes generating separated time-domain audio signals based on the refined separated source embeddings from the hybrid mask module.

### CROSS REFERENCE TO RELATED APPLICATIONS

This U.S. Patent Application claims priority under 35 U.S.C. § 119(e) to U.S. Provisional Application 63/793,566, filed on Apr. 23, 2025. The disclosure of this prior application is considered part of the disclosure of this application and is hereby incorporated by reference in its entirety.

### TECHNICAL FIELD

This disclosure relates to audio source separation by equivariant flow matching.

### BACKGROUND

Source separation is the task of recovering individual constituent signals from a mixture, with applications in audio processing, speech enhancement, and music production. Some single-channel approaches relied on methods such as independent component analysis or non-negative matrix factorization, which had limited success in the under-determined single-microphone scenario. Deep learning techniques represented a significant advancement, with deep clustering and permutation invariant training enabling supervised separation networks to achieve improved performance. Regression-based discriminative approaches are susceptible to artifacts such as mask-based distortions and often struggle to recover signals buried in strong interference. Generative models, including diffusion models and flow matching techniques, have demonstrated capacity for high-fidelity signal reconstruction by in-painting over missing information. However, applying generative approaches to source separation presents challenges, including maintaining mixture consistency and handling permutation symmetry of sources.

### SUMMARY

One aspect of the disclosure provides an audio source separation model executable on data processing hardware. The audio source separation model includes a splitter configured to receive, as input, a time-frequency representation of a mixture audio signal that includes two or more source signals and project the time-frequency representation onto a fixed-sized embedding vector that includes a time dimension, a frequency band dimension, a source dimension, and a features dimension. The audio source separation model also includes at least one attention block configured to receive, as input, the fixed-size embedding vector from the splitter and a diffusion time embedding and generate an output embedding vector. The audio source separation model also includes an unsplitter configured to receive, as input, the output embedding vector from the at least one attention block and generate a reconstructed time-frequency representation by averaging overlapping frequency bands to restore original frequency dimensions from the output embedding vector. The audio source separation model also includes a hybrid mask module configured to receive, as input, the reconstructed time-frequency representation from the unsplitter and an embedding derived from the mixture audio signal and generate refined separated source embeddings by combining the reconstructed time-frequency representation and the embedding derived from the mixture audio signal. The audio source separation model also includes an inverse transform module configured to receive, as input, the refined separated source embeddings from the hybrid mask module and generate, using an inverse Short-Time Fourtier Transform (iSTFT), separated time-domain audio signals.

Implementations of the disclosure may include one or more of the following optional features. In some implementations, the audio source separation model also includes a transform module configured to receive, as input, the mixture audio signal that includes the two or more source signals and generate, using a Short-Time Fourier Transform (STFT), the time-frequency representation. In some examples, the at least one attention block includes a plurality of attention blocks that include at least one band-stream joint attention (BSJA) layer and at least one time-stream parallel attention (TSPA) layer. Here, the at least one BSJA layer and the at least one TSPA layer are applied alternatively within the plurality of attention blocks.

In some implementations, the at least one attention block includes a band-stream joint attention (BSJA) layer configured to receive, as input, the fixed-size embedding vector and the diffusion time embedding and generate a band-stream joint attention embedding by applying attention jointly across the frequency band dimension and the source dimension of the fixed-size embedding vector. In these implementations, the BSJA layer may include: a multilayer perceptron (MLP) configured to receive, as input, the diffusion time embedding and generate scaling and shifting parameters; a Residual Mean Square (RMS) normalization layer configured to receive, as input, the fixed-size embedding vector from the splitter and generate a normalized embedding vector; a scaling and shifting layer configured to receive, as input, the normalized embedding vector from the RMS normalization layer and the scaling and shifting parameters from the MLP and generate a scaled and shifted embedding vector; an attention layer configured to receive, as input, the scaled and shifted embedding vector from the scaling and shifting layer and generate, using Convolutional Multi-Head Self-Attention (CMHSA) applied jointly across the frequency band dimension and the source dimension, an attention embedding; and a scaling layer configured to receive, as input, the attention embedding from the attention layer and the scaling and shifting parameters from the MLP and generate a scaled attention embedding. The BSJA layer may further include: a second RMS normalization layer configured to receive, as input, a concatenation of the fixed-size embedding vector and the scaled attention embedding and generate a second normalized embedding vector; a second scaling and shifting layer configured to receive, as input, the second normalized embedding vector from the second RMS normalization layer and the scaling and shifting parameters from the MLP and generate a second scaled and shifted embedding vector; a convolution layer configured to receive, as input, the second scaled and shifted embedding vector from the second scaling and shifting layer and generate a convolutional output; and a second scaling layer configured to receive, as input, the convolutional output from the convolutional layer and the scaling and shifting parameters from the MLP and generate a scaled convolutional output.

In some implementations, the at least one attention block includes a time-stream parallel attention TSPA layer configured to receive, as input, the fixed-size embedding vector and the diffusion time embedding and generate a time-stream parallel attention embedding by applying attention across the time dimension and the source dimension of the fixed-size embedding vector. In these implementations, the TSPA layer may include: a multilayer perceptron (MLP) configured to receive, as input, the diffusion time embedding and generate scaling and shifting parameters; a Residual Mean Square (RMS) normalization layer configured to receive, as input, the fixed-size embedding vector from the splitter and generate a normalized embedding vector; a scaling and shifting layer configured to receive, as input, the normalized embedding vector from the RMS normalization layer and the scaling and shifting parameters from the MLP and generate a scaled and shifted embedding vector, an attention layer configured to receive, as input, the scaled and shifted embedding vector from the scaling and shifting layer and generate, using Convolutional Multi-Head Self-Attention (CMHSA) applied jointly across the time dimension and the source dimension, an attention embedding; and a scaling layer configured to receive, as input, the attention embedding from the attention layer and the scaling and shifting parameters from the MLP and generate a scaled attention embedding. The TSPA may further include: a second RMS normalization layer configured to receive, as input, a concatenation of the fixed-size embedding vector and the scaled attention embedding and generate a second normalized embedding vector; a second scaling and shifting layer configured to receive, as input, the second normalized embedding vector from the second RMS normalization layer and the scaling and shifting parameters from the MLP and generate a second scaled and shifted embedding vector; a convolution layer configured to receive, as input, the second scaled and shifted embedding vector from the second scaling and shifting layer and generate a convolutional output; and a second scaling layer configured to receive, as input, the convolutional output from the convolutional layer and the scaling and shifting parameters from the MLP and generate a scaled convolutional output.

In some examples, the at least one attention block is further configured to receive, as input, an embedding derived from the mixture audio signal as a conditioning input. In some implementations, the audio source separation model is trained using a permutation equivariant training (PET) loss function. In these implementations, the PET loss function may include a first loss term determines at a first time using a permutation of target sources that minimizes the first loss term at the first time and a second loss term determined at a second time subsequent to the first time using the same permutation of target sources.

Another aspect of the disclosure provides a computer-implemented method executed on data processing hardware that causes the data processing hardware to perform operations. The operations include receiving, as input to an audio source separation model, a time-frequency representation of a mixture audio signal that includes two or more source signals and projecting, using a splitter of the audio source separation model, the time-frequency representation onto a fixed-sized embedding vector that includes a time dimension, a frequency band dimension, a source dimension, and a features dimension. The operations also include generating, using at least one attention block of the audio source separation model, an output embedding vector based on the fixed-sized embedding vector from the splitter and a diffusion time embedding. The operations also include generating, using an unsplitter of the audio source separation model, a reconstructed time-frequency representation by averaging overlapping frequency bands to restore original frequency dimensions from the output embedding vector. The operations also include generating, using a hybrid mask module of the audio source separation model, refined separated source embeddings by combining the reconstructed time-frequency representation and an embedding derived from the mixture audio signal. The operations also include generating, using an inverse Short-Time Fourier Transform (iSTFT) of the audio source separation model, separated time-domain audio signals based on the refined separated source embeddings from the hybrid mask module.

Implementations of the disclosure may include one or more of the following optional features. In some implementations, the operations further include generating, using a transform module of the audio source separation model, the time-frequency representation based on the mixture audio signal that includes the two or more source signals, the time frequency representation generated using a Short-Time Fourier Transform (STFT). In some examples, the at least one attention block includes a plurality of attention blocks that includes at least one band-stream joint attention (BSJA) layer and at least one time-stream parallel attention (TSPA) layer. Here, the at least one BSJA layer and the at least one TSPA layer are applied alternatively within the plurality of attention blocks.

In some implementations, the operations further include generating, using a band-stream joint attention (BSJA) layer of the at least one attention block, a band-stream joint attention embedding by applying attention jointly across the frequency band dimension and the source dimension of the fixed-sized embedding vector. In these implementations, the operations may further include: generating, using a multilayer perceptron (MLP) of the BSJA layer, scaling and shifting parameters based on the diffusion time embedding; generating, using a Residual Mean Square (RMS) normalization layer of the BSJA layer, a normalized embedding vector based on the fixed-sized embedding vector from the splitter; generating, using a scaling and shifting layer of the BSJA layer, a scaled and shifted embedding vector, based on the normalized embedding vector from the RMS normalization layer and the scaling and shifting parameters from the MLP; generating, using an attention layer of the BSJA layer, an attention embedding based on the scaled and shifted embedding vector from the scaling and shifting layer, the attention embedding generated using Convolutional Multi-Head Self-Attention (CMHSA) applied jointly across the frequency band dimension and the source dimension; and generating, using a scaling layer of the BSJA layer, a scaled attention embedding based on the attention embedding from the attention layer and the scaling and shifting parameters from the MLP. The operations may further include: generating, using a second RMS normalization layer of the BSJA layer, a second normalized embedding vector based on a concatenation of the fixed-sized embedding vector and the scaled attention embedding; generating, using a second scaling and shifting layer of the BSJA layer, a second scaled and shifted embedding vector based on the second normalized embedding vector from the second RMS normalization layer and the scaling and shifting parameters from the MLP; generating, using a convolutional layer of the BSJA layer, a convolutional output based on the second scaled and shifted embedding vector from the second scaling and shifting layer, and generating, using a second scaling layer of the BSJA layer, a scaled convolutional output based on the convolutional output from the convolutional layer and the scaling and shifting parameters from the MLP.

In some implementations, the operations further include generating, using a time-stream parallel attention (TSPA) layer of the at least one attention block, a time-stream parallel attention embedding by applying attention across the time dimension and the source dimension of the fixed-sized embedding vector. In these implementations, the operations may further include: generating, using a multilayer perceptron (MLP) of the TSPA layer, scaling and shifting parameters based on the diffusion time embedding; generating, using a Residual Mean Square (RMS) normalization layer of the TSPA layer, a normalized embedding vector based on the fixed-sized embedding vector from the splitter; generating, using a scaling and shifting layer of the TSPA layer, a scaled and shifted embedding vector based on the normalized embedding vector from the RMS normalization layer and the scaling and shifting parameters from the MLP; generating, using an attention layer of the TSPA layer, an attention embedding based on the scaled and shifted embedding vector from the scaling and shifting layer, the attention embedding generated using Convolutional Multi-Head Self-Attention (CMHSA) applied jointly across the time dimension and the source dimension; and generating, using a scaling layer of the TSPA layer, a scaled attention embedding based on the attention embedding from the attention layer and the scaling and shifting parameters from the MLP. The operations may further include: generating, using a second RMS normalization layer of the TSPA layer, a second normalized embedding vector based on a concatenation of the fixed-sized embedding vector and the scaled attention embedding; generating, using a second scaling and shifting layer of the TSPA layer, a second scaled and shifted embedding vector based on the second normalized embedding vector from the second RMS normalization layer and the scaling and shifting parameters from the MLP; generating, using a convolutional layer of the TSPA layer, a convolutional output based on the second scaled and shifted embedding vector from the second scaling and shifting layer; and generating, using a second scaling layer of the TSPA layer, a scaled convolutional output based on the convolutional output from the convolutional layer and the scaling and shifting parameters from the MLP.

In some examples, the operations further include receiving, as input to the at least one attention block, an embedding derived from the mixture audio signal as a conditioning input. In some implementations, the audio source separation model is trained using a permutation equivariant training (PET) loss function. In these implementations, the PET loss function may include a first loss term determined at a first time using a permutation of target sources that minimizes the first loss term at the first time and a second loss term determined at a second time subsequent to the first time using the same permutation of target sources.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic view of an example system including a source separation model.

FIG. 2 is a schematic view of a source separation model with equivariant flow matching.

FIG. 3 is a schematic view of one or more attention blocks of the source separation model.

FIG. 4 is a schematic view of an attention block that includes a band-stream joint attention (BSJA) layer.

FIG. 5 is a schematic view of an attention block that includes a time-stream parallel attention (TSPA) layer.

FIG. 6 is a schematic view of the hybrid mask module of the source separation model.

FIG. 7 is a flowchart of an example arrangement of operations for a computer-implemented method of performing audio separation.

FIG. 8 is a schematic view of an example computing device that may be used to implement the systems and methods described herein.

Like reference symbols in the various drawings indicate like elements.

### DETAILED DESCRIPTION

Source separation is the task of recovering individual constituent signals from a multi-source mixture, such as an audio recording containing overlapping speech or a music track with multiple instruments. In practical applications, particularly within the audio domain, the goal is to isolate each source signal from a single-channel mixture where only the combined signal is observed. Source separation has applications in audio processing, speech enhancement, and music production.

Early approaches to single-channel source separation relied on methods such as independent component analysis or non-negative matrix factorization. Multi-channel methods that exploit spatial diversity had some success, but the highly under-determined single-microphone scenario presented significant challenges. Deep learning techniques represented a significant advancement in the field, with deep clustering introducing learned embeddings for time-frequency bins of the short-time Fourier transform, allowing clustering by source and enabling separation by masking. End-to-end permutation invariant training enabled supervised separation networks to achieve improved performance on benchmark tasks. Regression-based discriminative approaches are susceptible to producing artifacts, such as mask-based distortions, and often struggle to recover signals buried in strong interference or low signal-to-noise ratio (SNR) environments. Discriminative models frequently yield outputs that lack fine-grained detail or high-frequency clarity. Moreover, regression-based methods may produce outputs that regress toward the mean, resulting in perceptually degraded reconstructions.

Generative models, including diffusion models and flow matching techniques, have demonstrated a capacity for high-fidelity signal reconstruction by in-painting over missing information. However, applying generative approaches to source separation presents challenges, including maintaining mixture consistency throughout the generation process and handling the inherent permutation symmetry of sources, where any ordering of the separated signals represents an equally valid solution. Existing generative separation frameworks have attempted to address mixture consistency and permutation symmetry through conditioning mechanisms and guidance terms, but may not fully preserve the constraint that separated sources must sum to the original mixture.

Accordingly, implementations herein are directed toward an audio source separation model that addresses mixture consistency and permutation symmetry. The audio source separation model uses an interpolating path between source and mixture distributions that preserves a common subspace, restricting noise to an orthogonal subspace. By employing a permutation equivariant formulation, the audio source separation model enables training of flow matching models that maintain the constraint

The audio source separation model may include a splitter, attention blocks, an unsplitter, a hybrid mask module, and an inverse transform module. The splitter receives a time-frequency representation of a mixture audio signal that includes two or more source signals and projects the time-frequency representation onto a fixed-sized embedding vector including a time dimension, a frequency band dimension, a source dimension, and a features dimension. The attention blocks receive the fixed-sized embedding vector and a diffusion time embedding to generate an output embedding vector. The unsplitter generates a reconstructed time-frequency representation by averaging overlapping frequency bands to restore original frequency dimensions from the output embedding vector. The hybrid mask module generates refined separated source embeddings by combining the reconstructed time-frequency representation and an embedding derived from the mixture audio signal. The inverse transform module generates separated time-domain audio signals using an inverse Short-Time Fourier Transform (iSTFT). The audio source separation model may use a permutation equivariant network architecture and be trained using a permutation equivariant training (PET) loss function.

Notably, to maintain permutation equivariance, interactions between the sources within the attention blocks are implemented using multi-head self-attention modules that omit any positional encoding for the sources. By contrast, the embedding derived from the mixture audio signal is added as an additional source conditioning input that includes a special positional encoding to explicitly differentiate the mixture from the sources within the attention blocks. To lift the dimensional distribution from the lower-dimensional mixture to match the source distribution, the generation process operates by filling the subspace orthogonal to the mixture with artificial noise, allowing the model to smoothly interpolate between the noise-augmented mixture and the separated sources.

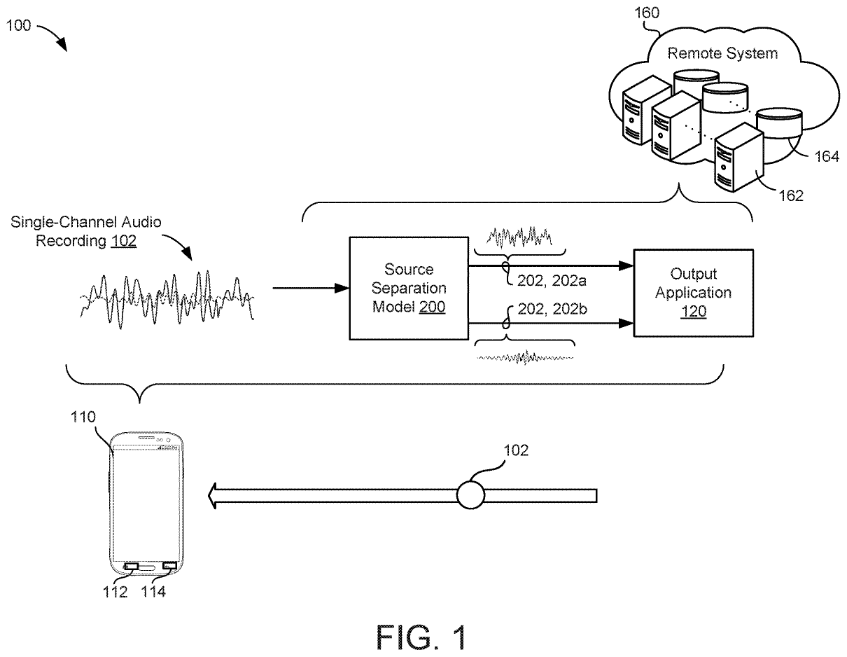

Referring to FIG. 1, in some implementations, a system 100 includes a remote system 160 in communication with a user device 110 associated with a respective user via a network, such as the Internet, a local area network (LAN), a wide area network (WAN), a cellular network, or a wireless network. In some examples, the system 100 obtains a multi-source audio recording 102 corresponding to audio with multiple overlapping signals. For instance, the multiple signals may include overlapping speech from two or more speakers, or a music track with multiple instruments. As such, the multi-source audio recording 102 may be referred to as a mixture 102 of multiple sources, whereby each source includes a corresponding one of the individual audio signals. The remote system 160 and/or the user device 110 may execute an audio source separation model 200 that provides the capability to reconstruct individual audio sources from mixed source audio data. Accordingly, implementations herein employ the audio source separation model 200 for separating individual sources from the mixture 102.

The user device 110 may correspond to any computing device capable of obtaining mixtures 102. Some examples of user devices 110 include, but are not limited to, mobile devices (e.g., mobile phones, tablets, laptops, etc.), computers, wearable devices (e.g., smart watches, smart headphones, etc.), smart appliances, internet of things (IoT) devices, smart speakers, and vehicle infotainment systems. The user device 110 includes data processing hardware 112 and memory hardware 114 in communication with the data processing hardware 112 and storing instructions that, when executed by the data processing hardware 112, cause the data processing hardware 112 to perform one or more operations. In some implementations, the audio source separation model 200 executes on the data processing hardware 112. The user device 110 may also include an audio input device (e.g., a microphone) and an audio output device (e.g., a speaker) for capturing and playing audio data, respectively. The user device 110 may further include a display device (e.g., a screen) for presenting audio processing information and interfaces to the user.

The remote system 160 may be a single computer, multiple computers, or a distributed system (e.g., a cloud environment) having scalable/elastic resources. The remote system includes data processing hardware 162 and memory hardware 164 in communication with the data processing hardware 162 and storing instructions that, when executed by the data processing hardware 162, cause the data processing hardware to perform one or more operations. The remote system 160 is configured to communicate with the user device 110 via the network. The audio source separation model 200 may be executed by the remote system 160 in addition to, or in lieu of, executing on the user device 110.

In some examples, the user device 110 obtains the multi-source audio recording 102 corresponding to audio with multiple overlapping signals. In some examples, the multi-source audio recording 102 is converted into an input for the audio source separation model 200. The audio source separation model 200 may process the multi-source audio recording 102 and output a first source 202, 202a separated from the mixture 102 that constitutes a clean audio signal associated with a first speaker and a second source 202, 202b separated from the mixture 102 that constitutes a clean audio signal associated with a second speaker.

The individual sources 202 separated from the mixture 102 by the audio source separation model 200 may be provided to an output application 120. For example, the output application 120 may include an automatic speech recognition system configured to process clean speech from a target speaker separated from a specific mixture. In another example, the output application 120 includes a music editing tool that allows a user to manipulate a specific separated source 202 independently of other sources 202. For instance, the individual sources separated from the mixture 102 may include individual sounds originating from a respective type of music instrument. In yet another example, the output application 120 includes a post-processing module for video generation, enabling the separation of a singing voice from a generated song to facilitate reediting of a video file with a new prompt. The output application 120 may execute on the user device 110 or the remote system 160. The output application 120 may represent an application (e.g., a media editing software interface, an audio playback application, or a downstream downstream processing pipeline) that utilizes the clean, separated time-domain signals 202a, 202b independent of one another.

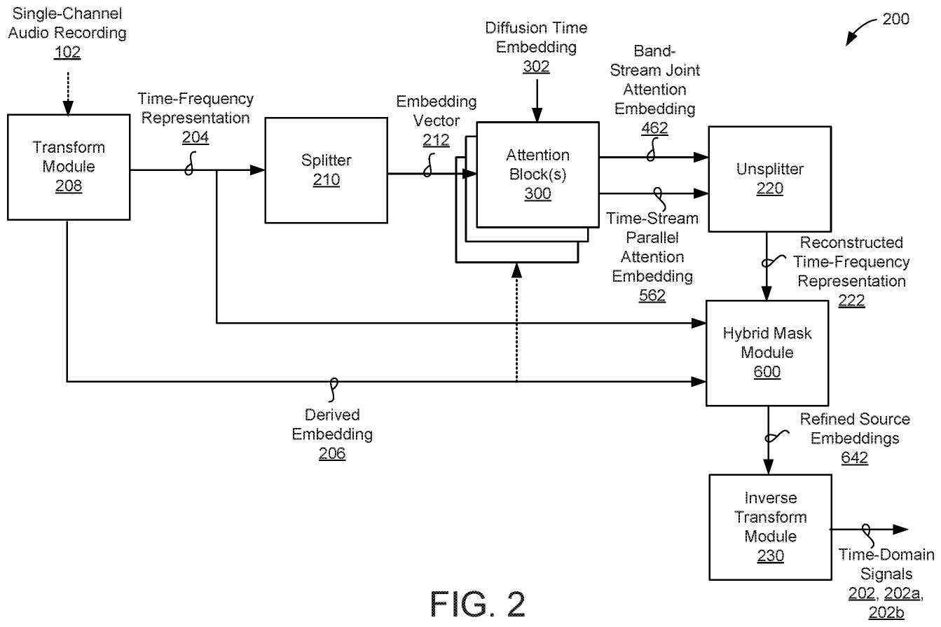

Referring now to FIG. 2, in some implementations, an audio source separation model 200 separates the mixture 102 into separated time-domain audio signals 202. The audio source separation model 200 may receive a time-frequency representation 204 of the mixture 102 and a derived embedding 206 of the mixture 102. That is, the audio source separation model 200 may include a transform module 208 that generates the time-frequency representation 204 from the mixture 102. The transform module 208 also generates the derived embedding 206 from the mixture 102, the time-frequency representation 204, or both. For example, the transform module 208 applies a Short-Time Fourier Transform (STFT) to the mixture 102 to produce the time-frequency representation 204. In some instances, the transform module 208 further applies complex magnitude compression to the time-frequency representation 204. The derived embedding 206 represents a conditioning variable, which provides prior information about source activity to the audio source separation model 200. While the transform module 208 may generate the time-frequency representation 204 and the derived embeddings 206, some examples provide the time-frequency representation 204 and the derived embedding 206 directly to the audio source separation model 200 from an external data source. The audio source separation model 200 treats the derived embedding 206 as an additional source for conditioning, employing a specific positional encoding to distinguish the mixture 102 from the individual sources 202 during processing.

In some implementations, the audio source separation model 200 includes a splitter 210. The splitter 210 receives the time-frequency representation 204 of the mixture 102 as an input. The splitter 210 projects the time-frequency representation 204 onto a fixed-sized embedding vector 212. The fixed-sized embedding vector 212 defines a multi-dimensional data tensor that includes a time dimension, a frequency band dimension, a source dimension, and a features dimension. For example, the splitter 210 organizes the data such that the fixed-sized embedding vector 212 serves as the primary data structure for downstream processing within the audio source separation model 200. The splitter 210 may include a learnable mel-band splitting layer. The mel-band splitting layer projects irregularly shaped or non-uniform frequency bands from the time-frequency representation 204 into the fixed-sized embedding vector 212. The projection enables the audio source separation model 200 to process high-resolution audio data while maintaining a consistent internal dimensionality. By arranging the data into these specific dimensions, the splitter 210 prepares the fixed-sized embedding vector 212 for permutation equivariant operations that treat each source within the source dimension in a parallel manner.

The audio source separation model 200 includes at least one attention block 300 configured to process high-dimensional audio data. The at least one attention block 300 receives, as input, the fixed-sized embedding vector 212 from the splitter 210 and a diffusion time embedding 302. In some implementations, the at least one attention block 300 also receives the derived embedding 206 as a conditioning variable. The derived embedding 206 may include one or more positional encodings that distinguish the mixture 102 from individual source signals within the attention blocks 300. The at least one attention block 300 processes the fixed-sized embedding vector 212 and the diffusion time embedding 302 to generate an output embedding vector 462, 562. For example, the at least one attention block 300 applies attention mechanisms, such as multi-head self-attention, across dimensions of the fixed-sized embedding vector 212 to model dependencies between different sources and frequency bands.

The audio source separation model 200 includes an unsplitter 220 configured to generate a reconstructed time-frequency representation 222. The unsplitter 220 receives the output embedding vector 462, 562 and transforms the compressed feature space back into a frequency-domain format. In some implementations, the unsplitter 220 generates the reconstructed time-frequency representation 222 by performing a mel-band unsplit operation. The unsplit operation may include averaging overlapping frequency bands to restore original frequency dimensions from the output embedding vector 462, 562. Through the unsplit operation, the reconstructed time-frequency representation 222 recovers the frequency resolution of the time-frequency representation 204 that the splitter 210 previously projected into the fixed-sized embedding vector 212. For instance, if the splitter 210 maps eighty mel-bands to the features dimension, the unsplitter 220 reverses such mapping to ensure the reconstructed time-frequency representation 222 matches the spectral structure required for subsequent source refinement and inverse transformation.

The audio source separation model 200 includes a hybrid mask module 600 configured to generate refined separated source embeddings 642. The hybrid mask module 600 receives the reconstructed time-frequency representation 222 from the unsplitter 220. Additionally, the hybrid mask module 600 may receive a derived embedding 206 via a skip connection that bypasses the splitter 210 and the at least one attention block 300. The hybrid mask module 600 generates the refined separated source embeddings 642 by combining the reconstructed time-frequency representation 222 and the derived embedding 206. In some implementations, the hybrid mask module 600 processes the time-frequency representation 204 in combination with the reconstructed time-frequency representation 222 and the derived embedding 206. For example, the hybrid mask module 600 projects an output from a mel-band unsplit operation to a larger dimensionality and splits the projected output into a mapping component, an input mask, and a mixture mask. The hybrid mask module 600 then applies the input mask to the reconstructed time-frequency representation 222 and applies the mixture mask to the derived embedding 206. By weighting and summing the reconstructed time-frequency representation 222 and the derived embedding 206 with the mapping component, the hybrid mask module 600 produces the refined separated source embeddings 642. The masking operation allows the audio source separation model 200 to utilize information from the original mixture 102 to refine the separated signals. For instance, the hybrid mask module 600 may use the mixture mask to ensure that the refined separated source embeddings 642 remain consistent with the observed energy levels of the mixture 102.

The audio source separation model 200 may include an inverse transform module 230 that receives the refined separated source embeddings 642 from the hybrid mask module 600 and generates separated time-domain audio signals 202. To reconstruct the audio waveform for each identified source, the inverse transform module 230 may apply an inverse Short-Time Fourier Transform (iSTFT) to the refined separated source embeddings 642. In some examples, the separated time-domain audio signals 202 include a first separated time-domain audio signal 202, 202a and a second separated time-domain audio signal 202, 202b. For example, in a scenario where the mixture 102 includes two speakers, the inverse transform module 230 produces the first separated time-domain audio signal 202a as a clean waveform for a first speaker and the second separated time-domain audio signal 202b as a clean waveform for a second speaker. By performing the iSTFT, the inverse transform module 230 maps the processed spectral data back to a time-domain representation, allowing the audio source separation model 200 to output high-fidelity audio data. The inverse transform module 230 restores the original temporal structure of the signals by reversing the spectral decomposition initially performed during the generation of the time-frequency representation 204. Through such processing, the inverse transform module 230 provides the individual sources 202 in a format suitable for playback or for use within a downstream output application 120 (FIG. 1).

In some implementations, the at least one attention block 300 is further configured to receive the embedding 206 derived from the mixture audio signal 102 as a conditioning input. The conditioning input provides the at least one attention block 300 with global information regarding the mixture 102 to assist in identifying and separating the constituent source signals. Moreover, the audio source separation model 200 may be trained using a permutation equivariant training (PET) loss function. The PET loss function includes a first loss term and a second loss term. The first loss term is determined at a first time using a permutation of target sources that minimizes the first loss term at that first time. The second loss term is determined at a second time subsequent to the first time. Notably, the second loss term is determined using the same permutation of target sources that was determined to minimize the first loss term at the first time. This approach allows the audio source separation model 200 to learn a consistent assignment of sources across different timesteps of a generative trajectory.

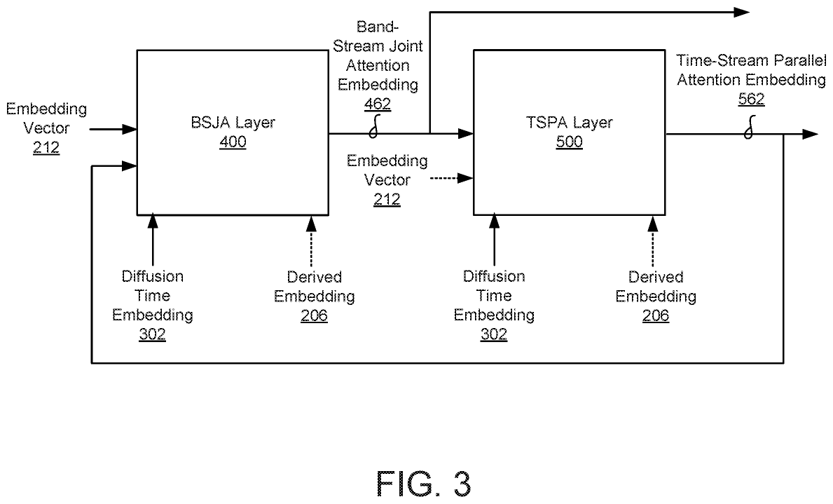

Referring now to FIG. 3, in some implementations, the at least one attention block 300 includes a plurality of attention blocks 300 that each include at least one band-stream joint attention (BSJA) layer 400 and at least one time-stream parallel attention (TSPA) layer 500. The BSJA layer 400 receives the fixed-sized embedding vector 212 and the diffusion time embedding 302 to generate a band-stream joint attention embedding 462. To model dependencies between frequency components and individual sources, the BSJA layer 400 applies attention jointly across the frequency band dimension and the source dimension of the fixed-sized embedding vector 212. The TSPA layer 500 receives the fixed-sized embedding vector 212 and the diffusion time embedding 302 to generate a time-stream parallel attention embedding 562. The TSPA layer 500 captures temporal dynamics by applying attention across the time dimension and the source dimension of the fixed-sized embedding vector 212.

In some implementations, the at least one attention block 300 includes a pipeline where the BSJA layer 400 and the TSPA layer 500 are applied alternatively. For example, the audio source separation model 200 may pass the fixed-sized embedding vector 212 through the BSJA layer 400 and then pass the resulting band-stream joint attention embedding 462 into the TSPA layer 500. The alternating architecture may repeat for each attention block 300 within a dual-path transformer pipeline. In some examples, the time-stream parallel attention embedding 562 routes back to an input of a subsequent BSJA layer 400 for further processing iterations. The plurality of attention blocks 300 may include a first BSJA layer 400 and a first TSPA layer 500 for a first iteration and a second BSJA layer 400 and a second TSPA layer 500 for a second iteration. Following a final iteration through the alternating layers, the plurality of attention blocks 300 outputs the resulting time-stream parallel attention embedding 562 as the output embedding vector 562.

In some implementations, the at least one attention block 300 includes the BSJA layer 400 to process the fixed-sized embedding vector 212 without a corresponding TSPA layer 500. In such cases, the band-stream joint attention embedding 462 generated by the BSJA layer 400 serves as the output embedding vector 462 directly. To preserve permutation equivariance, the BSJA layer 400 and the TSPA layer 500 perform interactions between sources using multi-head self-attention modules that omit positional encodings for the source dimension. By contrast, the attention layers may use convolutional multi-head self-attention (CMHSA) that employs convolutional projections along the time dimension or the frequency band dimension to maintain local modeling. Moreover, the attention blocks 300 may use a multilayer perceptron to process the diffusion time embedding 302 into scaling and shifting parameters, which adaptively normalize the fixed-sized embedding vector 212 before and after attention operations.

The at least one attention block 300 processes multi-dimensional audio data to facilitate source separation while maintaining permutation equivariance. In some implementations, the at least one attention block 300 receives a combination of the fixed-sized embedding vector 212, the diffusion time embedding 302, and the derived embedding 206 to generate the output embedding vector 462, 562. For example, a first attention block 300 in a sequence receives the fixed-sized embedding vector 212 directly from the splitter 210, whereas subsequent attention blocks 300 receive an output embedding vector 462, 562 from a previous layer as a primary input. The at least one attention block 300 integrates the diffusion time embedding 302 to condition the separation process on a specific timestep of a flow matching or diffusion trajectory.

To provide global context during the reconstruction of individual sources, the at least one attention block 300 utilizes the derived embedding 206 as a conditioning input. In some examples, the audio source separation model 200 appends the derived embedding 206 to the fixed-sized embedding vector 212 as an additional entry along the source dimension. Because the mixture 102 possesses a different statistical distribution than the individual source signals, the derived embedding 206 includes a specific positional encoding. The specific positional encoding allows the at least one attention block 300 to differentiate the mixture 102 from the target sources within the source dimension of the multi-dimensional data tensor.

The at least one attention block 300 generates the output embedding vector 462, 562 by applying attention mechanisms that model complex interactions across the dimensions of the fixed-sized embedding vector 212. In some implementations, the at least one attention block 300 applies attention jointly across the frequency band dimension and the source dimension. By performing joint attention across these dimensions, the at least one attention block 300 captures spectral correlations between different sources, such as overlapping harmonics in speech or music. For instance, the at least one attention block 300 may use the diffusion time embedding 302 to modulate the attention weights, thereby varying the focus of the model between coarse mixture structures at early flow stages and fine-grained source details at later flow stages. This joint processing ensures that the model treats each source in a parallel, equivariant manner while leveraging frequency-dependent features to distinguish between constituent signals.

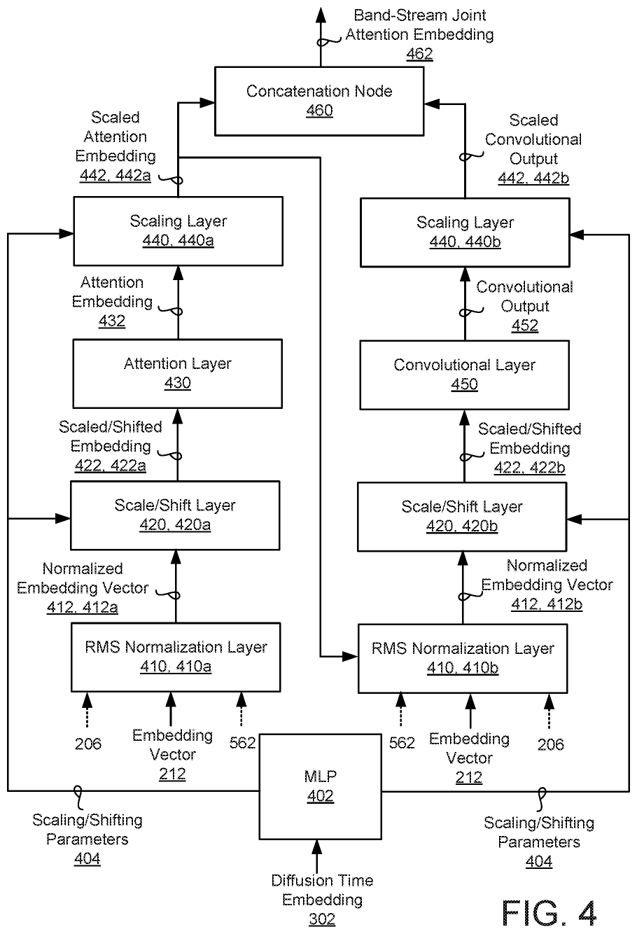

Referring now to FIG. 4, in some implementations, the BSJA layer 400 includes a multilayer perceptron (MLP) 402, Residual Mean Square (RMS) normalization layers 410, scaling and shifting layers 420, an attention layer 430, scaling layers 440, a convolutional layer 450, and a concatenation node 460. The MLP 402 receives the diffusion time embedding 302 as input and processes the diffusion time embedding 302 to generate scaling and shifting parameters 404. The scaling and shifting parameters 404 allow the BSJA layer 400 to adaptively modulate feature maps based on a specific diffusion or flow matching timestep. A first RMS normalization layer 410, 410a receives the fixed-sized embedding vector 212 and generates a first normalized embedding vector 412, 412a. In some examples, the first RMS normalization layer 410a also receives the derived embedding 206 of the mixture 102 or a time-stream parallel attention embedding 562 from a previous TSPA layer 500 to produce the first normalized embedding vector 412a. A first scaling and shifting layer 420,420a receives the first normalized embedding vector 412a from the first RMS normalization layer 410a and the scaling and shifting parameters 404 from the MLP 402. The first scaling and shifting layer 420a applies the scaling and shifting parameters 404 to the first normalized embedding vector 412a to generate a first scaled and shifted embedding vector 422, 422a.

The attention layer 430 receives the first scaled and shifted embedding vector 422a. The attention layer 430 generates an attention embedding 432 by applying Convolutional Multi-Head Self-Attention (CMHSA) jointly across the frequency band dimension and the source dimension of the first scaled and shifted embedding vector 422a. By applying CMHSA, the attention layer 430 utilizes convolutional projections along the frequency band dimension to capture local spectral patterns while simultaneously modeling global interactions between different sources. A first scaling layer 440, 440a receives the attention embedding 432 and the scaling and shifting parameters 404 to generate a first scaled attention embedding 442, 442a. The first scaling layer 440,440a modulates the magnitude of the attention embedding 432 before further processing within the BSJA layer 400.

A second RMS normalization layer 410, 410b receives a combination of the fixed-sized embedding vector 212 and the first scaled attention embedding 442a. The second RMS normalization layer 410b generates a second normalized embedding vector 412, 412b. In some implementations, the second RMS normalization layer 410b also receives the derived embedding 206 of the mixture 102 or the time-stream parallel attention embedding 562 from a previous TSPA layer 500 to produce the second normalized embedding vector 412b. A second scaling and shifting layer 420, 420b receives the second normalized embedding vector 412b and the scaling and shifting parameters 404 from the MLP 402. The second scaling and shifting layer 420b applies the scaling and shifting parameters 404 to the second normalized embedding vector 412b to generate a second scaled and shifted embedding vector 422, 422b.

The convolutional layer 450 receives the second scaled and shifted embedding vector 422b. The convolutional layer 450 generates a convolutional output 452 by applying convolutional projections along the frequency band dimension. For example, the convolutional layer 450 may utilize a gated linear unit non-linearity, such as a Conv-SwishGLU, to capture local dependencies within the spectral features. A second scaling layer 440, 440b receives the convolutional output 452 and the scaling and shifting parameters 404 to generate a scaled convolutional output 442, 442b. The concatenation node 460 receives the first scaled attention embedding 442a and the scaled convolutional output 442b. The concatenation node 460 generates the BSJA embedding 462 by merging the first scaled attention embedding 442a and the scaled convolutional output 442b. By combining the global interactions from the attention layer 430 and the local spectral modeling from the convolutional layer 450, the BSJA layer 400 produces a comprehensive band-stream joint attention embedding 462 that preserves permutation equivariance across the source dimension.

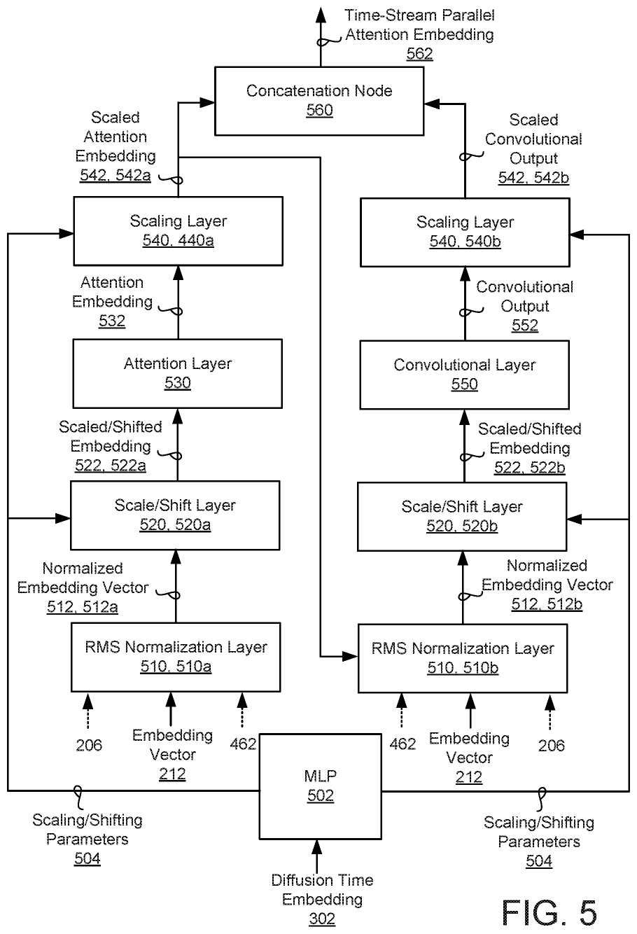

Referring now to FIG. 5, in some implementations, the TSPA layer 500 includes a MLP 502, RMS normalization layers 510, scaling and shifting layers 520, an attention layer 530, scaling layers 540, a convolutional layer 550, and a concatenation node 560. The MLP 502 receives the diffusion time embedding 302 as input and processes the diffusion time embedding 302 to generate scaling and shifting parameters 504. The scaling and shifting parameters 504 allow the TSPA layer 500 to adaptively modulate feature maps based on a specific diffusion or flow matching timestep. A first RMS normalization layer 510, 510a receives the fixed-sized embedding vector 212 and generates a first normalized embedding vector 512, 512a. In some examples, the first RMS normalization layer 510a also receives the derived embedding 206 of the mixture 102 or a band-stream joint attention embedding 462 from a previous band-stream joint attention (BSJA) layer 400 to produce the first normalized embedding vector 512a. A first scaling and shifting layer 520, 520a receives the first normalized embedding vector 512a from the first RMS normalization layer 510a and the scaling and shifting parameters 504 from the MLP 502. The first scaling and shifting layer 520a applies the scaling and shifting parameters 504 to the first normalized embedding vector 512a to generate a first scaled and shifted embedding vector 522, 522a.

The attention layer 530 receives the first scaled and shifted embedding vector 522a. The attention layer 530 generates an attention embedding 532 by applying Convolutional Multi-Head Self-Attention (CMHSA) across the time dimension and the source dimension of the first scaled and shifted embedding vector 522a. By applying CMHSA, the attention layer 530 utilizes convolutional projections along the time dimension to capture temporal patterns while simultaneously modeling global interactions between different sources. A first scaling layer 540, 540a receives the attention embedding 532 and the scaling and shifting parameters 504 to generate a first scaled attention embedding 542, 542a. The first scaling layer 540a modulates the magnitude of the attention embedding 532 before further processing within the TSPA layer 500.

A second Residual Mean Square (RMS) normalization layer 510, 510b receives a combination of the fixed-sized embedding vector 212 and the first scaled attention embedding 542a. The second RMS normalization layer 510b generates a second normalized embedding vector 512, 512b. In some examples, the second RMS normalization layer 510b also receives the derived embedding 206 of the mixture 102 or a band-stream joint attention embedding 462 from a previous band-stream joint attention (BSJA) layer 400 to produce the second normalized embedding vector 512b. A second scaling and shifting layer 520, 520b receives the second normalized embedding vector 512b and the scaling and shifting parameters 504 from the MLP 502. The second scaling and shifting layer 520b applies the scaling and shifting parameters 504 to the second normalized embedding vector 512b to generate a second scaled and shifted embedding vector 522, 522b.

The convolutional layer 550 receives the second scaled and shifted embedding vector 522b. The convolutional layer 550 generates a convolutional output 552 by applying convolutional projections along the time dimension. For instance, the convolutional layer 550 may utilize a gated linear unit non-linearity, such as a Conv-SwishGLU, to capture local temporal dependencies. A second scaling layer 540, 540b receives the convolutional output 552 and the scaling and shifting parameters 504 to generate a second scaled convolutional output 542, 542b. The concatenation node 560 receives the first scaled attention embedding 542a and the second scaled convolutional output 542b. The concatenation node 560 generates the time-stream parallel attention (TSPA) embedding 562 by merging the first scaled attention embedding 542a and the second scaled convolutional output 542b. By combining the global temporal and source interactions from the attention layer 530 and the local temporal modeling from the convolutional layer 550, the TSPA layer 500 produces a comprehensive time-stream parallel attention embedding 562 that preserves permutation equivariance across the source dimension.

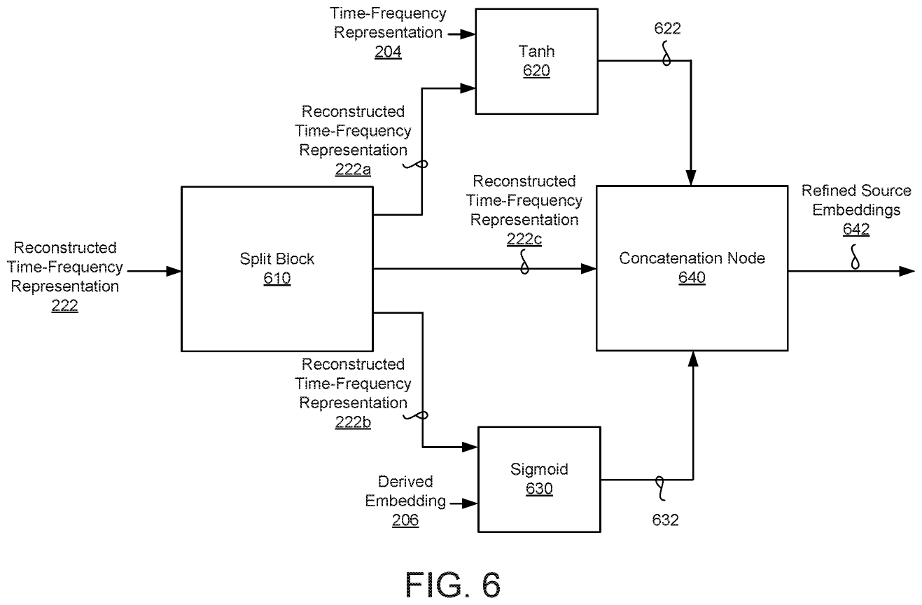

Referring now to FIG. 6, in some implementations, the hybrid mask module 600 includes a split block 610, a tanh module 620, a sigmoid module 630, and a concatenation node 640. The hybrid mask module 600 refines the separated sources by integrating information from the original mixture audio signal 102. The split block 610 receives the reconstructed time-frequency representation 222 from the unsplitter 220 and projects the reconstructed time-frequency representation 222 to a larger dimensionality, such as three times the original size. The split block 610 then partitions the projected output into a first reconstructed time-frequency representation 222a serving as a mapping component, a second reconstructed time-frequency representation 222b serving as an input mask, and a third reconstructed time-frequency representation 222c serving as a mixture mask.

The tanh module 620 receives the first reconstructed time-frequency representation 222a and the time-frequency representation 204. The tanh module 620 applies a hyperbolic tangent non-linearity to the mapping component to generate a first output 622. The sigmoid module 630 receives the second reconstructed time-frequency representation 222b and the third reconstructed time-frequency representation 222c to generate masking weights. In some examples, the hybrid mask module 600 applies the second reconstructed time-frequency representation 222b as an input mask to the reconstructed time-frequency representation 222 and applies the third reconstructed time-frequency representation 222c as a mixture mask to the derived embedding 206 of the mixture audio signal 102. The sigmoid module 630 generates a second output 632 representing the weighted combination of the reconstructed features and the conditioning mixture information.

The concatenation node 640 generates the refined separated source embeddings 642 by combining the first output 622 and the second output 632. For example, the hybrid mask module 600 uses the mixture mask to extract relevant energy envelopes from the derived embedding 206, which provides a prior for source activity. The hybrid mask module 600 then merges these masked components with the mapping component to produce the refined separated source embeddings 642. By weighting the reconstructed time-frequency representation 222 against the observed mixture audio signal 102, the hybrid mask module 600 maintains mixture consistency and reduces regression artifacts in the final separated signals. The refined separated source embeddings 642 then pass to the inverse transform module 230 for conversion into the separated time-domain audio signals 202.

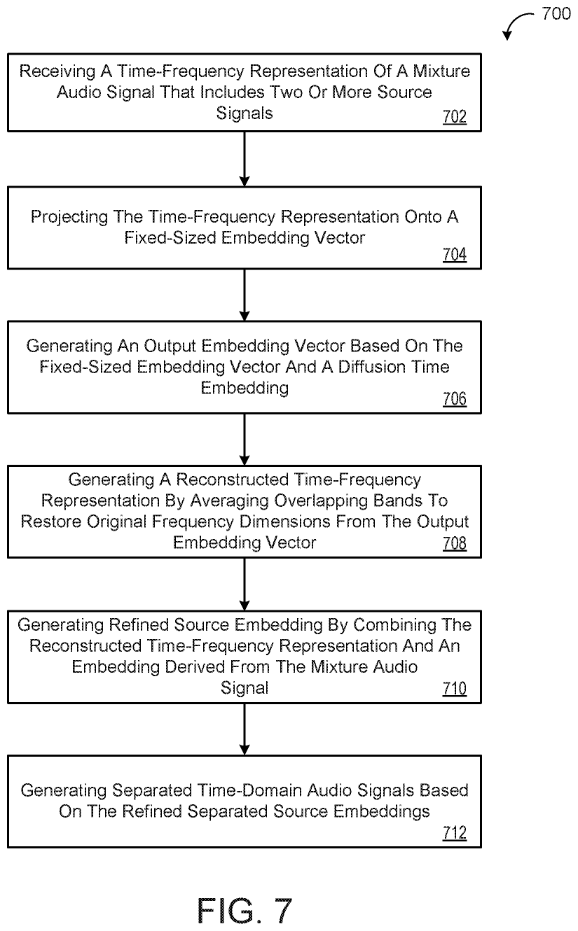

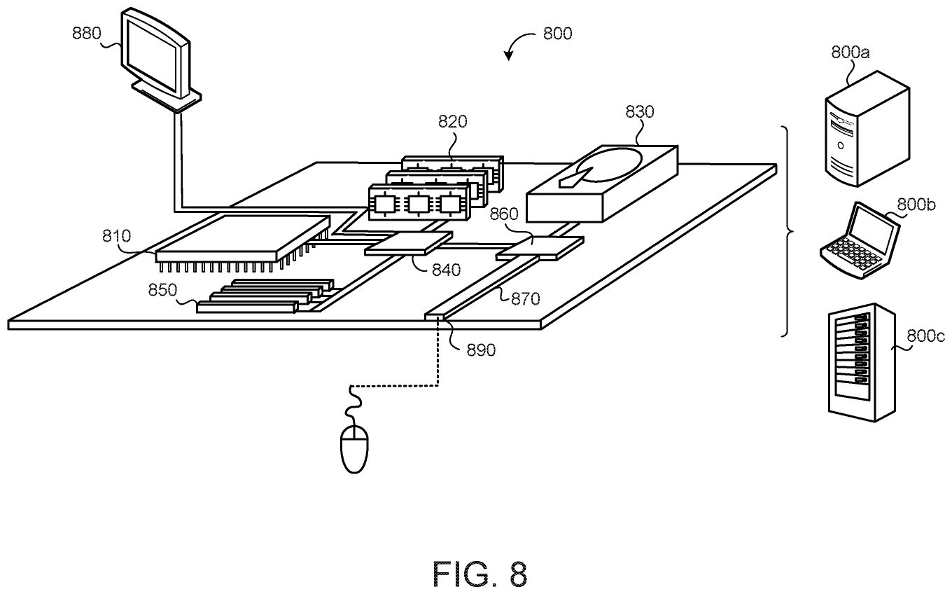

FIG. 7 is a flowchart of an example arrangement of operations for a computer-implemented method 700 of performing source separation. The method 700 may execute on data processing hardware 810 (FIG. 8) using instructions stored on memory hardware 820 (FIG. 8). The data processing hardware 810 and the memory hardware 820 may reside on the user device 110 and/or the remote computing system 160 of FIG. 1 each corresponding to the computing device 800 (FIG. 8).

At operation 702, the method 700 includes receiving, as input to an audio source separation model 200, a time-frequency representation 204 of a mixture audio signal 102 that includes two or more source signals. At operation 704, the method 700 includes projecting, using a splitter 210 of the audio source separation model 200, the time-frequency representation 204 onto a fixed-sized embedding vector 212 that includes a time dimension, a frequency band dimension, a source dimension, and a features dimension. At operation 706, the method 700 includes generating, using at least one attention block 300 of the audio source separation model 200, an output embedding vector 462, 562 based on the fixed-sized embedding vector 212 from the splitter and a diffusion time embedding 302. At operation 708, the method 700 includes generating, using an unsplitter 220 of the audio source separation model 200, a reconstructed time-frequency representation 222 by averaging overlapping frequency bands to restore original frequency dimensions from the output embedding vector 462, 562. At operation 710, the method 700 includes generating, using a hybrid mask module 600 of the audio source separation model 200, refined separated source embeddings 642 by combining the reconstructed time-frequency representation 222 and an embedding 206 derived from the mixture audio signal 102. At operation 712, the method 700 includes generating, using an iSTFT module 230 of the audio source separation model 200, separated time-domain audio signals 202 based on the refined separated source embeddings 642 from the hybrid mask module.

As such, the audio source separation model 200 provides a generative framework for source separation that maintains strict mixture consistency. By defining an interpolating path between a mixture distribution and a source distribution, the audio source separation model 200 preserves a common subspace while restricting noise to an orthogonal subspace. To match the dimensionality of the two or more source signals, the audio source separation model 200 augments the mixture 102 with artificial noise, allowing for a smooth interpolation between the noise-augmented mixture and the separated sources 202. This configuration enables the audio source separation model 200 to utilize a flow matching objective that ensures the sum of the reconstructed sources matches the original mixture 102 throughout the generation process.

Moreover, the audio source separation model 200 employs a permutation equivariant formulation to address the inherent permutation symmetry of source separation. The at least one attention block 300 utilizes a permutation equivariant network architecture that treats each source within a source dimension in a parallel manner, omitting positional encodings for the sources to prevent arbitrary ordering bias. Through the alternating application of the BSJA layer 400 and the TSPA layer 500, the audio source separation model 200 captures complex spectral correlations and temporal dynamics while maintaining equivariance. The training of the audio source separation model 200 using the PET loss function facilitates the learning of consistent source assignments by determining a minimizing permutation at an initial timestep and maintaining that same permutation across subsequent timesteps of a generative trajectory.

Thus, the audio source separation model 200 performs high-fidelity signal reconstruction that avoids artifacts common in regression-based approaches, such as mask-based distortions or the loss of high-frequency clarity. By employing the hybrid mask module 600, the audio source separation model 200 integrates observed energy envelopes from the mixture 102 as a prior for source activity, which improves the recovery of signals buried in strong interference or low signal-to-noise ratio environments. Additionally, the use of the splitter 210 and the unsplitter 220 for mel-band processing allows the audio source separation model 200 to handle high-resolution audio data with a consistent internal dimensionality, leading to improved computational efficiency and better preservation of fine-grained audio details compared to models that lack a specialized band-split architecture.

FIG. 8 is a schematic view of an example computing device 800 that may be used to implement the systems and methods described in this document. The computing device 800 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 800 includes a processor 810, memory 820, a storage device 830, a high-speed interface/controller 840 connecting to the memory 820 and high-speed expansion ports 850, and a low speed interface/controller 860 connecting to a low speed bus 870 and a storage device 830. Each of the components 810, 820, 830, 840, 850, and 860, are interconnected using various busses, and may be mounted on a common motherboard or in other manners as appropriate. The processor 810 can process instructions for execution within the computing device 800, including instructions stored in the memory 820 or on the storage device 830 to display graphical information for a graphical user interface (GUI) on an external input/output device, such as display 880 coupled to high speed interface 840. In other implementations, multiple processors and/or multiple buses may be used, as appropriate, along with multiple memories and types of memory. Also, multiple computing devices 800 may be connected, with each device providing portions of the necessary operations (e.g., as a server bank, a group of blade servers, or a multi-processor system).

The memory 820 stores information non-transitorily within the computing device 800. The memory 820 may be a computer-readable medium, a volatile memory unit(s), or non-volatile memory unit(s). The non-transitory memory 820 may be physical devices used to store programs (e.g., sequences of instructions) or data (e.g., program state information) on a temporary or permanent basis for use by the computing device 800. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 830 is capable of providing mass storage for the computing device 800. In some implementations, the storage device 830 is a computer-readable medium. In various different implementations, the storage device 830 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer-or machine-readable medium, such as the memory 820, the storage device 830, or memory on processor 810.

The high speed controller 840 manages bandwidth-intensive operations for the computing device 800, while the low speed controller 860 manages lower bandwidth-intensive operations. Such allocation of duties is exemplary only. In some implementations, the high-speed controller 840 is coupled to the memory 820, the display 880 (e.g., through a graphics processor or accelerator), and to the high-speed expansion ports 850, which may accept various expansion cards (not shown). In some implementations, the low-speed controller 860 is coupled to the storage device 830 and a low-speed expansion port 890. The low-speed expansion port 890, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 800 may be implemented in a number of different forms, as shown in the figure. For example, it may be implemented as a standard server 500a or multiple times in a group of such servers 800a, as a laptop computer 800b, or as part of a rack server system 800c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

What is claimed is:

1. A system comprising data processing hardware and memory hardware in communication with the data processing hardware and storing instructions that when executed on the data processing hardware causes the data processing hardware to execute an audio source separation model, the audio source separation model comprising:
a splitter configured to:
receive, as input, a time-frequency representation of a mixture audio signal comprising two or more source signals; and
project the time-frequency representation onto a fixed-sized embedding vector comprising a time dimension, a frequency band dimension, a source dimension, and a features dimension;
at least one attention block configured to:
receive, as input, the fixed-sized embedding vector from the splitter and a diffusion time embedding; and
generate an output embedding vector;
an unsplitter configured to:
receive, as input, the output embedding vector from the at least one attention block; and
generate a reconstructed time-frequency representation by averaging overlapping frequency bands to restore original frequency dimensions from the output embedding vector;
a hybrid mask module configured to:
receive, as input, the reconstructed time-frequency representation from the unsplitter and an embedding derived from the mixture audio signal; and
generate refined separated source embeddings by combining the reconstructed time-frequency representation and the embedding derived from the mixture audio signal; and
an inverse transform module configured to:
receive, as input, the refined separated source embeddings from the hybrid mask module; and
generate, using an inverse Short-Time Fourier Transform (iSTFT), separated time-domain audio signals.

2. The system of claim 1, wherein the audio source separation module further comprises a transform module configured to:
receive, as input, the mixture audio signal comprising the two or more source signals; and
generate, using a Short-Time Fourier Transform (STFT), the time-frequency representation.

3. The system of claim 1, wherein:
the at least one attention block comprises a plurality of attention blocks comprising at least one band-stream joint attention (BSJA) layer and at least one time-stream parallel attention (TSPA) layer; and
the at least one BSJA layer and the at least one TSPA layer are applied alternatively within the plurality of attention blocks.

4. The system of claim 1, wherein the at least one attention block comprises a band-stream joint attention (BSJA) layer configured to:
receive, as input, the fixed-sized embedding vector and the diffusion time embedding; and
generate a band-stream joint attention embedding by applying attention jointly across the frequency band dimension and the source dimension of the fixed-sized embedding vector.

5. The system of claim 4, wherein the BSJA layer comprises:
a multilayer perceptron (MLP) configured to:
receive, as input, the diffusion time embedding; and
generate scaling and shifting parameters;
a Residual Mean Square (RMS) normalization layer configured to:
receive, as input, the fixed-sized embedding vector from the splitter; and
generate a normalized embedding vector;
a scaling and shifting layer configured to:
receive, as input, the normalized embedding vector from the RMS normalization layer and the scaling and shifting parameters from the MLP, and
generate a scaled and shifted embedding vector;
an attention layer configured to:
receive, as input, the scaled and shifted embedding vector from the scaling and shifting layer; and
generate, using Convolutional Multi-Head Self-Attention (CMHSA) applied jointly across the frequency band dimension and the source dimension, an attention embedding; and
a scaling layer configured to:
receive, as input, the attention embedding from the attention layer and the scaling and shifting parameters from the MLP; and
generate a scaled attention embedding.

6. The system of claim 5, wherein the BSJA layer further comprises:
a second RMS normalization layer configured to:
receive, as input, a concatenation of the fixed-sized embedding vector and the scaled attention embedding; and
generate a second normalized embedding vector;
a second scaling and shifting layer configured to:
receive, as input, the second normalized embedding vector from the second RMS normalization layer and the scaling and shifting parameters from the MLP; and
generate a second scaled and shifted embedding vector;
a convolutional layer configured to:
receive, as input, the second scaled and shifted embedding vector from the second scaling and shifting layer; and
generate a convolutional output; and
a second scaling layer configured to:
receive, as input, the convolutional output from the convolutional layer and the scaling and shifting parameters from the MLP; and
generate a scaled convolutional output.

7. The system of claim 1, wherein the at least one attention block comprises a time-stream parallel attention (TSPA) layer configured to:
receive, as input, the fixed-sized embedding vector and the diffusion time embedding; and
generate a time-stream parallel attention embedding by applying attention across the time dimension and the source dimension of the fixed-sized embedding vector.

8. The system of claim 7, wherein the TSPA layer comprises:
a multilayer perceptron (MLP) configured to:
receive, as input, the diffusion time embedding; and
generate scaling and shifting parameters;
a Residual Mean Square (RMS) normalization layer configured to:
receive, as input, the fixed-sized embedding vector from the splitter; and
generate a normalized embedding vector;
a scaling and shifting layer configured to:
receive, as input, the normalized embedding vector from the RMS normalization layer and the scaling and shifting parameters from the MLP, and
generate a scaled and shifted embedding vector, an attention layer configured to:
receive, as input, the scaled and shifted embedding vector from the scaling and shifting layer; and
generate, using Convolutional Multi-Head Self-Attention (CMHSA) applied jointly across the time dimension and the source dimension, an attention embedding; and
a scaling layer configured to:
receive, as input, the attention embedding from the attention layer and the scaling and shifting parameters from the MLP; and
generate a scaled attention embedding.

9. The system of claim 8, wherein the TSPA layer further comprises:
a second RMS normalization layer configured to:
receive, as input, a concatenation of the fixed-sized embedding vector and the scaled attention embedding; and
generate a second normalized embedding vector;
a second scaling and shifting layer configured to:
receive, as input, the second normalized embedding vector from the second RMS normalization layer and the scaling and shifting parameters from the MLP; and
generate a second scaled and shifted embedding vector;
a convolutional layer configured to:
receive, as input, the second scaled and shifted embedding vector from the second scaling and shifting layer; and
generate a convolutional output; and
a second scaling layer configured to:
receive, as input, the convolutional output from the convolutional layer and the scaling and shifting parameters from the MLP; and
generate a scaled convolutional output.

10. The system of claim 1, wherein the at least one attention block is further configured to receive, as input, an embedding derived from the mixture audio signal as a conditioning input.

11. The system of claim 1, wherein the audio source separation model is trained using a permutation equivariant training (PET) loss function.

12. The system of claim 11, wherein the PET loss function comprises:
a first loss term determined at a first time using a permutation of target sources that minimizes the first loss term at the first time; and
a second loss term determined at a second time subsequent to the first time using the same permutation of target sources.

13. A computer-implemented method executing on data processing hardware that causes the data processing hardware to perform operations comprising:
receiving, as input to an audio source separation model, a time-frequency representation of a mixture audio signal comprising two or more source signals;
projecting, using a splitter of the audio source separation model, the time-frequency representation onto a fixed-sized embedding vector comprising a time dimension, a frequency band dimension, a source dimension, and a features dimension;
generating, using at least one attention block of the audio source separation model, an output embedding vector based on the fixed-sized embedding vector from the splitter and a diffusion time embedding;
generating, using an unsplitter of the audio source separation model, a reconstructed time-frequency representation by averaging overlapping frequency bands to restore original frequency dimensions from the output embedding vector;
generating, using a hybrid mask module of the audio source separation model, refined separated source embeddings by combining the reconstructed time-frequency representation and an embedding derived from the mixture audio signal; and
generating, using an inverse Short-Time Fourier Transform (iSTFT) of the audio source separation model, separated time-domain audio signals based on the refined separated source embeddings from the hybrid mask module.

14. The method of claim 13, wherein the operations further include generating, using a transform module of the audio source separation model, the time-frequency representation based on the mixture audio signal comprising the two or more source signals, the time frequency representation generated using a Short-Time Fourier Transform (STFT).

15. The method of claim 13, wherein:
the at least one attention block comprises a plurality of attention blocks comprising at least one band-stream joint attention (BSJA) layer and at least one time-stream parallel attention (TSPA) layer; and
the at least one BSJA layer and the at least one TSPA layer are applied alternatively within the plurality of attention blocks.

16. The method of claim 13, wherein the operations further comprise generating, using a band-stream joint attention (BSJA) layer of the at least one attention block, a band-stream joint attention embedding by applying attention jointly across the frequency band dimension and the source dimension of the fixed-sized embedding vector.

17. The method of claim 16, wherein the operations further comprise:
generating, using a multilayer perceptron (MLP) of the BSJA layer, scaling and shifting parameters based on the diffusion time embedding;
generating, using a Residual Mean Square (RMS) normalization layer of the BSJA layer, a normalized embedding vector based on the fixed-sized embedding vector from the splitter;
generating, using a scaling and shifting layer of the BSJA layer, a scaled and shifted embedding vector, based on the normalized embedding vector from the RMS normalization layer and the scaling and shifting parameters from the MLP;
generating, using an attention layer of the BSJA layer, an attention embedding based on the scaled and shifted embedding vector from the scaling and shifting layer, the attention embedding generated using Convolutional Multi-Head Self-Attention (CMHSA) applied jointly across the frequency band dimension and the source dimension; and
generating, using a scaling layer of the BSJA layer, a scaled attention embedding based on the attention embedding from the attention layer and the scaling and shifting parameters from the MLP.

18. The method of claim 17, wherein the operations further comprise:
generating, using a second RMS normalization layer of the BSJA layer, a second normalized embedding vector based on a concatenation of the fixed-sized embedding vector and the scaled attention embedding;
generating, using a second scaling and shifting layer of the BSJA layer, a second scaled and shifted embedding vector based on the second normalized embedding vector from the second RMS normalization layer and the scaling and shifting parameters from the MLP;
generating, using a convolutional layer of the BSJA layer, a convolutional output based on the second scaled and shifted embedding vector from the second scaling and shifting layer; and
generating, using a second scaling layer of the BSJA layer, a scaled convolutional output based on the convolutional output from the convolutional layer and the scaling and shifting parameters from the MLP.

19. The method of claim 13, wherein the operations further include generating, using a time-stream parallel attention (TSPA) layer of the at least one attention block, a time-stream parallel attention embedding by applying attention across the time dimension and the source dimension of the fixed-sized embedding vector.

20. The method of claim 19, wherein the operations further include;
generating, using a multilayer perceptron (MLP) of the TSPA layer, scaling and shifting parameters based on the diffusion time embedding;
generating, using a Residual Mean Square (RMS) normalization layer of the TSPA layer, a normalized embedding vector based on the fixed-sized embedding vector from the splitter;
generating, using a scaling and shifting layer of the TSPA layer, a scaled and shifted embedding vector based on the normalized embedding vector from the RMS normalization layer and the scaling and shifting parameters from the MLP;
generating, using an attention layer of the TSPA layer, an attention embedding based on the scaled and shifted embedding vector from the scaling and shifting layer, the attention embedding generated using Convolutional Multi-Head Self-Attention (CMHSA) applied jointly across the time dimension and the source dimension; and
generating, using a scaling layer of the TSPA layer, a scaled attention embedding based on the attention embedding from the attention layer and the scaling and shifting parameters from the MLP.

21. The method of claim 20, wherein the operations further comprise:
generating, using a second RMS normalization layer of the TSPA layer, a second normalized embedding vector based on a concatenation of the fixed-sized embedding vector and the scaled attention embedding;
generating, using a second scaling and shifting layer of the TSPA layer, a second scaled and shifted embedding vector based on the second normalized embedding vector from the second RMS normalization layer and the scaling and shifting parameters from the MLP;
generating, using a convolutional layer of the TSPA layer, a convolutional output based on the second scaled and shifted embedding vector from the second scaling and shifting layer; and
generating, using a second scaling layer of the TSPA layer, a scaled convolutional output based on the convolutional output from the convolutional layer and the scaling and shifting parameters from the MLP.

22. The method of claim 13, wherein the operations further comprise receiving, as input to the at least one attention block, an embedding derived from the mixture audio signal as a conditioning input.

23. The method of claim 13, wherein the audio source separation model is trained using a permutation equivariant training (PET) loss function.

24. The method of claim 23, wherein the PET loss function comprises:
a first loss term determined at a first time using a permutation of target sources that minimizes the first loss term at the first time; and
a second loss term determined at a second time subsequent to the first time using the same permutation of target sources.
